(19) United States
(12) Patent Application Publication
(10) Pub. No.: US 2009/0185147 A1
(43) Pub. Date: Jul. 23, 2009

(54) PROJECTOR IMAGE PRINTING SYSTEM

(75) Inventors: Ramanathan Alaganchetty, Singapore (SG); Vivek Chopra, Singapore (SG); Sandeep Kumar Arya, Singapore (SG)

Correspondence Address: HAYNES AND BOONE, LLP;IP Section, 2323 Victory Avenue, Suite 700, Dallas, TX, 75219, US

(73) Assignee: DELL PRODUCTS L.P., Round Rock, TX (US)

(21) Appl. No.: 12/017,456

(22) Filed: Jan. 22, 2008

(51) Int. Cl. G03B 21/00

(52) U.S. Cl. 353/121

(57) ABSTRACT

In a projector image printing system, a projector receives an image, projects the image from the projector, and communicates the image from the projector to a printer. In an embodiment, a projector includes a graphics connectivity to receive an image from an information handling system (IHS), a projection system to project the image away from the projector, a graphics capture system to capture the image as a data file, and a communication system to communicate the data file to a printer. In another embodiment, a method to print an image from a projector includes receiving a print instruction from a user, converting a projected screen by the projector to an image, and sending the image to a printer.

### BACKGROUND

The present disclosure relates generally to information handling systems, and more particularly to a projector image printing system.

As the value and use of information continues to increase, individuals and businesses seek additional ways to process and store information. One option is an information handling system (IHS). An IHS generally processes, compiles, stores, and/or communicates information or data for business, personal, or other purposes. Because technology and information handling needs and requirements may vary between different applications, IHSs may also vary regarding what information is handled, how the information is handled, how much information is processed, stored, or communicated, and how quickly and efficiently the information may be processed, stored, or communicated. The variations in IHSs allow for IHSs to be general or configured for a specific user or specific use such as financial transaction processing, airline reservations, enterprise data storage, or global communications. In addition, IHSs may include a variety of hardware and software components that may be configured to process, store, and communicate information and may include one or more computer systems, data storage systems, and networking systems.

Presentations are often given using a projector to project an image (presentation material) from an IHS to a screen or wall in a size large enough for the audience to view the image via a projector. It would be beneficial to be able to print the presentation material so members of the audience can use it for later reference. However, the presenter may only have a portable IHS having the digital files of the presentation material and no means of printing the images. Additionally, printing the presentation material while away from the presenter's home or office may be limited due to a lack of proper printer driver or access to printers in a network environment at the site of the presentation. Furthermore the presenter may not be comfortable in sharing the full soft version of presentation material and sometime even if such presentation material is shared, the interested party may not have specific application to display the presentation material. Still more, network administrators at the site of the presentation may not want to give access to the presenter for use of a local network to print the presentation material.

Accordingly, it would be desirable to provide an improved projector image printing system absent the deficiencies described above.

### SUMMARY

According to one embodiment, a projector image printing system includes one or more subsystems to receive an image into a projector, project the image from the projector, and communicate the image from the projector to a printer.

### BRIEF DESCRIPTION OF THE DRAWINGS

FIG. 1 illustrates an embodiment of an information handling system (IHS).

FIG. 2 illustrates an embodiment of a projector image printing system.

FIG. 3 illustrates a screen shot of an embodiment of a network printer setup screen.

FIG. 4 illustrates an embodiment of a method to add a shared network printer.

FIG. 5 illustrates an embodiment of a method to print a projected image.

### DETAILED DESCRIPTION

For purposes of this disclosure, an IHS 100 includes any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an IHS 100 may be a personal computer, a network storage device, or any other suitable device and may vary in size, shape, performance, functionality, and price. The IHS 100 may include random access memory (RAM), one or more processing resources such as a central processing unit (CPU) or hardware or software control logic, read only memory (ROM), and/or other types of nonvolatile memory. Additional components of the IHS 100 may include one or more disk drives, one or more network ports for communicating with external devices as well as various input and output (I/O) devices, such as a keyboard, a mouse, and a video display. The IHS 100 may also include one or more buses operable to transmit communications between the various hardware components.

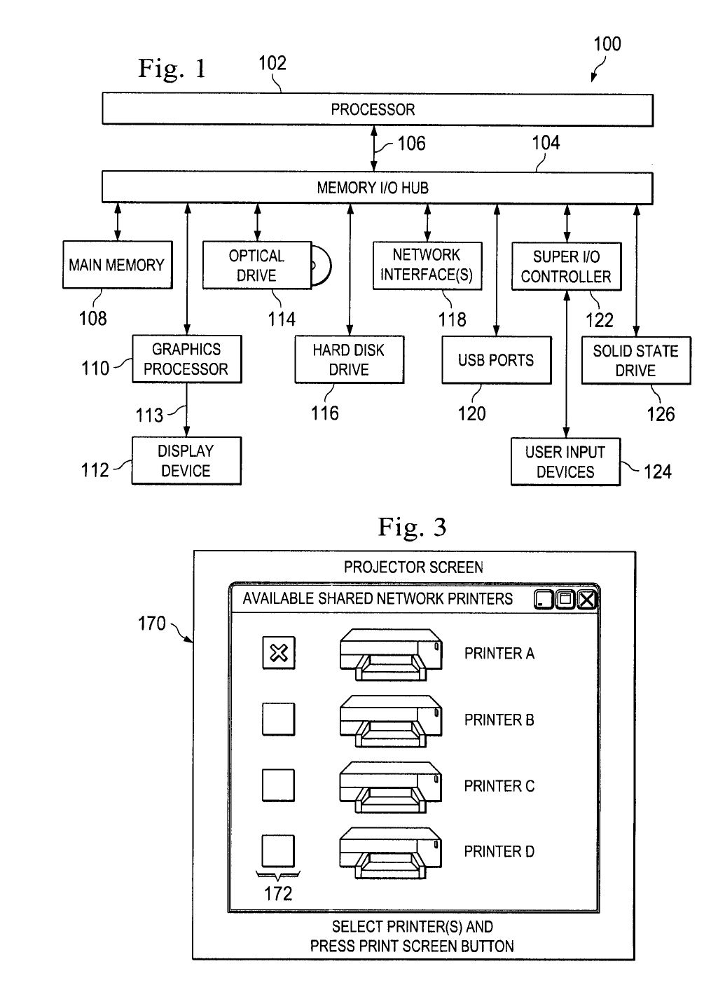

FIG. 1 is a block diagram of one IHS 100. The IHS 100 includes a processor 102 such as an Intel Pentium™ series processor or any other processor available. A memory I/O hub chipset 104 (comprising one or more integrated circuits) connects to processor 102 over a front-side bus 106. Memory I/O hub 104 provides the processor 102 with access to a variety of resources. Main memory 108 connects to memory I/O hub 104 over a memory or data bus. A graphics processor 110 also connects to memory I/O hub 104, allowing the graphics processor to communicate, e.g., with processor 102 and main memory 108. Graphics processor 110, in turn, provides display signals to a display device 112 via a graphics connectivity 113. The graphics connectivity 113 may be wired, or wireless and may use VGA, high definition, and/or other type of communication to communicate information between the graphics processor 110 of an IHS 100 to the display device 112.

Other resources can also be coupled to the system through the memory I/O hub 104 using a data bus, including an optical drive 114 or other removable-media drive, one or more hard disk drives 116, one or more network interfaces 118, one or more Universal Serial Bus (USB) ports 120, and a super I/O controller 122 to provide access to user input devices 124, etc. The IHS 100 may also include a solid state drive (SSDs) 126. It is understood that any or all of the drive devices 114, 116, and 126 may be located locally with the IHS 100, located remotely from the IHS 100, and/or they may be virtual with respect to the IHS 100.

Not all IHSs 100 include each of the components shown in FIG. 1, and other components not shown may exist. Furthermore, some components shown as separate may exist in an integrated package or be integrated in a common integrated circuit with other components, for example, the processor 102 and the memory I/O hub 104 can be combined together. As can be appreciated, many systems are expandable, and include or can include a variety of components, including redundant or parallel resources.

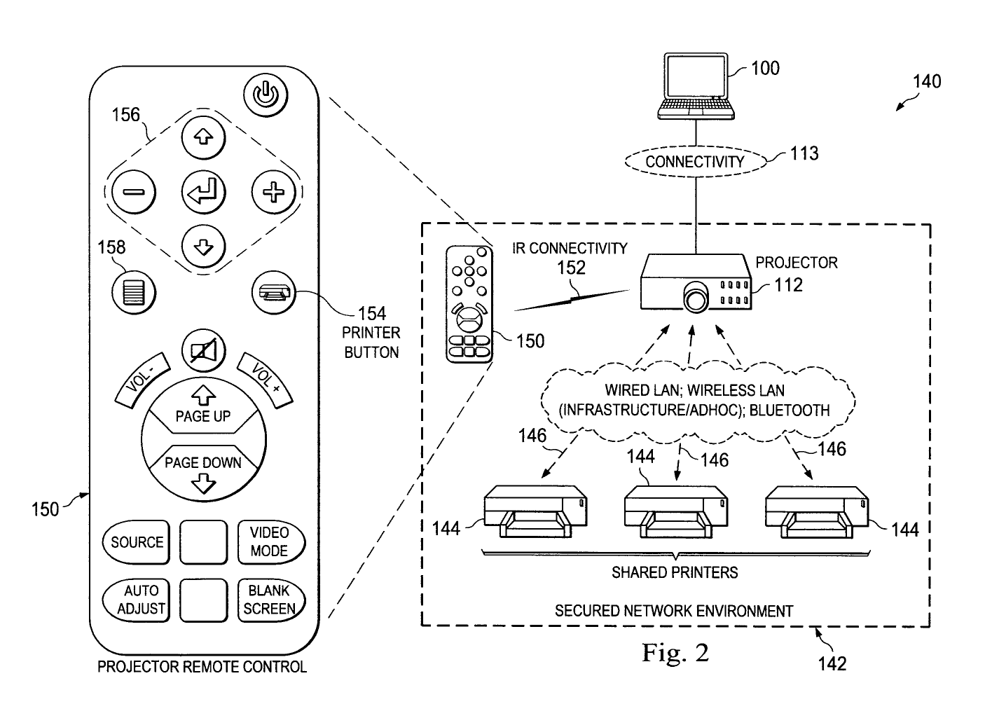

FIG. 2 illustrates an embodiment of a projector image printing system 140. In an embodiment, the display device (e.g., an image projector) 112 couples with an IHS 100 via a connectivity 113. As commonly understood in the art, images may be communicated from the IHS 100 to the projector 112 via the connectivity 113 for projecting/displaying. For example, an image may be created, downloaded, or otherwise obtained by the IHS 100 sent to the projector 112 and the projector 112 may then project the image to a screen, wall, or other surface using high intensity lighting.

The projector 112 may connect with a network 142 for communicating between components of the network 142. In an embodiment, the network 142 is a secured network and may only be accessed by authorization. The network 142 may be a wide area network (WAN), local area network (LAN), or a personal area network (PAN, e.g., Bluetooth). The network 142 may connect components of the network 142 by cables or wires or wirelessly. In an example, a presenter may provide the images to be projected using the projector 112 via the presenter's IHS 100, but neither the presenter nor the presenter's IHS 100 may have access to the network 142. Thus, the presenter would not gain access to the network 142 to distribute files of the images or send files of the images to a printer connected to the network 142.

In an embodiment, the projector image printing system 140 includes one or more printers 144. The projector 112 may communicate with one or more of the printers 144 using a projector/printer communication 146. In an embodiment, the projector/printer communication 146 may be WAN, LAN, and/or PAN communication.

When instructed, the projector 112 may capture the image being projected/displayed by creating an image file relating to the image. In an embodiment, the projector may capture the image similar to using a print screen option on an IHS 100. However, other methods for capturing the image by the projector 112 may be used. Then, the projector 112 may communicate the image file to one or more printers 144 via a communication 146. After receiving the image file, the printer 144 may then print the image. In an embodiment, the projector 112 may send a single image at a time to the printer 144 and in an embodiment, the projector 112 may send multiple images to the printer 144.

A projector control device 150 controls operations of the projector 112 via a projector control communication 152. In an embodiment, the projector control communication 152 is wired or otherwise coupled communication and in an embodiment, the projector control communication 152 is wireless communication (e.g., infrared (IR), ultra high frequency (UHF), radio frequency (RF), or any other wireless communication).

In an embodiment, the projector control device 150 includes a print button 154, setup buttons 156 and/or a menu button 158. The print button 154 instructs the projector 112 to enter a print mode to print the captured image. The setup buttons 156 allow the user to setup printing options (e.g., page to print, select printer, printer options, and a variety of other options). The menu button 158 allows a user to enter setup configurations for the projector 112.

FIG. 3 illustrates a screen shot of an embodiment of a network printer setup screen 170. Thus, if the menu button 158 is pressed, the projector 112 may project/display a setup screen 170 such as, the one shown in FIG. 3. Then, the user may use the setup buttons 156 on the control device 150 to make printer setup selections. For example, the user may select a setup field 172 for the desired printer 144. In an embodiment, the user may press the up and/or down setup buttons 156 to indicate the desired printer for printing the image from the projector 144. Then, the user may press the enter button in the setup buttons 156 enter the selection into the projector 144. It is to be understood that other control buttons 154, 156, and/or 158 may be used to control operation of printing from the projector 112 to a printer 144. Other setup screens are not shown for simplicity, but should be readily understood by one having ordinary skill in the art.

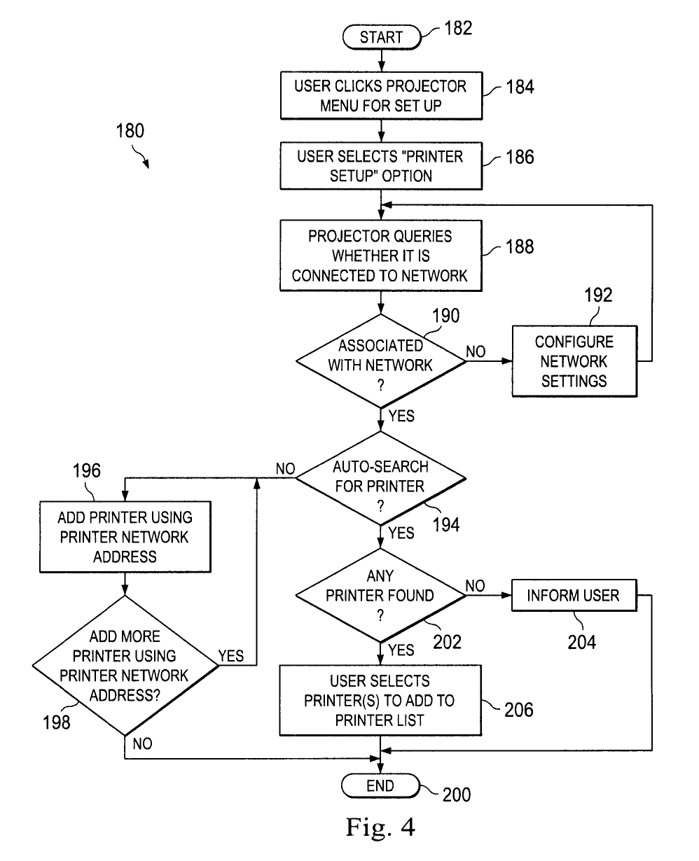

FIG. 4 illustrates an embodiment of a method 180 to add a shared network printer 144. The method 180 begins at 182 where the projector 112 is coupled with a network 142. The method then proceeds to block 184 when a user presses a setup button (e.g., menu button 158) on the control device 150. The method 180 then proceeds to block 186 when the user selects a printer setup option. Then, the method 180 proceeds to block 188 where the method 180 queries whether the projector is connected to a network 142. The method 180 then proceeds to decision block 190 where the method 180 determines whether the projector 112 is associated with a network 142. If no, the projector 112 is not associated with a network 142, the method 180 proceeds to block 192 where the method 180 allows a user to configure the network settings for the projector 112. After network settings are completed the method 180 returns to block 188. If yes, the projector 112 is associated with a network 142 in decision block 190, the method 180 proceeds to decision block 194 where the method 180 determines whether the projector 112 is to auto search for a printer 144 on the network 142. If no, the projector 112 is not to auto search for a printer 144, the method 180 proceeds to block 196 where a user may add a printer 144 to a list of available printers 144 for the projector 112. For example, the user may enter a network address for a printer 144 to the projector 112. After a printer 144 is added, the method 180 proceeds to decision block 198 where the method 180 determines whether more printers are to be added to a list of available printers 144 for the projector 112. If no, more printers 144 are not to be added, the method ends at 200. If yes, the more printers 144 are to be added, the method returns to block 196. Returning now to decision block 194, if yes, the method 180 is to auto search for a printer 144, the method 180 proceeds to decision block 202 where the method 180 determines whether a printer 144 is found on the network 142 by the projector 112. If no, no printer 144 is found on the network 142, the method 180 proceeds to block 204. At block 204, the method 180 informs the user that no printer has been found on the network 142 and then the method 180 ends at 200. If yes, a printer 144 is found on the network 142, the method 180 proceeds to block 206 where the user is allowed to select a printer 144 to add to a printer list such as, by using the selection field 172 on the projector print screen 170. After the user selects a printer 144, the method 180 ends at 200.

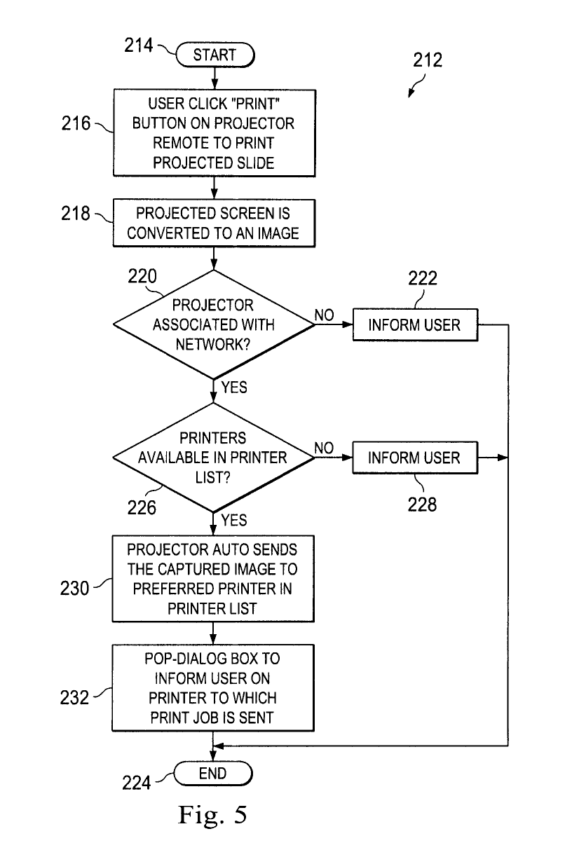

FIG. 5 illustrates an embodiment of a method 212 to print a projected image from a projector 112. The method 212 starts at 214 where the projector 112 is projecting/displaying an image. The method 212 proceeds to block 216 when a user presses the print button 154 on the control device 150. The method 212 then proceeds to block 218 where the projected image is converted to an image file capable of being received by a printer 144 and printed. In an embodiment, the image may be converted to an image file similarly to using a print screen button on an IHS, as is commonly understood by one having ordinary skill in the art. The method 212 then proceeds to decision block 220, where the method 212 determines whether the projector 112 is associated with a network 142. If no, the projector 112 is not associated with a network 142, the method 212 proceeds to block 222 where the method 212 informs the user that the projector 112 is not associated with a network 142 and then the method 212 ends at 224. If yes, the projector 112 is associated with a network 142, the method 212 proceeds to decision block 226 where the method 212 determines whether there are printers 144 available in a printer list. If no, printers 144 are not available in a printer list, the method 212 proceeds to block 228 where the method 212 informs the user that printers 144 are not available in the printer list and then the method 212 ends at 224. If yes, printers 144 are available in the printer list, the method 212 proceeds to block 230 where the projector 112 sends the captured image to the preferred or selected printer 144 in the printer list. The method 212 then proceeds to block 232 where the projector 112 projects/displays a dialog box to inform the user that the print image file has been sent to a printer 144.

In summary, an embodiment of the projector image printing system 140 enables direct printing of presentation material projected on a screen using a printer 144, such as a shared printer 144. In other words, printing the screen shot using a projector 112. Printing is enabled using a print Button 154 on the projector control device 150 without the need of printer driver to be installed on the IHS 100 that is used to make presentation (e.g., no interventions are required on the host IHS 100 (used to make presentation) to enable the printing). At the presentation site, the presenter does not have access to the host's network 142 environment, which may be access controlled. To make presentation, the presenter usually connects his/her IHS 100 to the available projector 112 through a VGA or similar connectivity 113 even if the projector 112 is associated with a network 142. In an embodiment, the projector 112 may communicate with the shared network printer devices 144 via wireless or wired LAN; and connectivity between the projector 112 and remote control 150 may be via IR communication. Network settings configuration may be first performed on the projector 112 so that projector 112 is associated with a network 142 and able to communicate with other devices on the same network 132. Depending on the connectivity type such as wireless, wired LAN, or others, a predefined network configuration method can be used. To add a printer 144 to the projector's 112 printer list, a user (usually a network administrator) may select the printer setup option, which is provided under a projector setup menu, such as via the menu button 158. A User may use an auto-search option that will locate shared printers 144 that are available on the same network 142 as projector or input the network address of the printer 144. After a printer search, available printers 144 are listed as illustrated in FIG. 3. Once a printer 144 is found it is then added to the projector's printer list. In an embodiment, at any time during the presentation, the user may select the print button 154 on the projector control device 150 to print the projected contents. Data projected on the screen may be captured as an image (e.g., JPEG or other image format). The projected captured image may then be sent to a preferred network printer 144 in the projector's printer list via wired or wireless protocols. The projector image printing system enables easy printing of presentation material. Direct printing of presentation material via a projector 112 in an environment different than the presenter's is possible, even when a presentation in progress

Although illustrative embodiments have been shown and described, a wide range of modification, change and substitution is contemplated in the foregoing disclosure and in some instances, some features of the embodiments may be employed without a corresponding use of other features. Accordingly, it is appropriate that the appended claims be construed broadly and in a manner consistent with the scope of the embodiments disclosed herein.

1. A projector image printing system, the system comprising one or more subsystems to:
receive an image into a projector;
project the image from the projector;
communicate the image from the projector to a printer;
communicate the image from the projector to the printer via a network;
remotely control communication of the image from the projector to the printer; and
select the printer to receive the image from the projector from a plurality of printers.

2. (canceled)

3. The system of claim 1, wherein the network is a local area network (LAN) or a personal area network (PAN).

4. The system of claim 1, wherein the network communicates wirelessly between the projector and the printer.

5. (canceled)

6. The system of claim 1, wherein the image is communicated from the projector to the printer as a graphic image file.

7. (canceled)

8. A projector comprising:
a graphics connectivity to receive an image from an information handling system (IHS);
a projection system to project the image away from the projector;
a graphics capture system to capture the image as a data file; and
a communication system to communicate the data file to a printer.

9. The projector of claim 8, further comprising:
a control device to receive an input from a user and instruct the projector to communicate the data file to the printer.

10. The projector of claim 9, wherein the control device is a wireless remote control device.

11. The projector of claim 9, wherein the control device includes a dedicated print button to receive the input from the user.

12. The projector of claim 8, operable to communicate the data file to the printer via a network.

13. The projector of claim 8, wherein the printer is selected from a plurality of available printers on a network.

14. A method to print an image from a projector, the method comprising:
receiving a print instruction from a user;
converting a projected screen by the projector to an image;
sending the image to a printer;
allowing the user to select a printer where to send the image;
determining whether the selected printer is available; and
informing the user about sending the image to the printer.

15-17. (canceled)

18. The method of claim 14, wherein converting a projected screen by the projector to an image converts the projected screen to a graphics data file.

19. The method of claim 14, wherein the projected screen is receive by the projector from an information handling system (IHS).

20. A projector image printing system comprising:
an information handling system (IHS);
a projector to receive an image file from the IHS and convert the image file to an image to project out of the projector,
a controller communicatively coupled with the projector to receive an instruction from a user to capture the projected image as a print screen function;
a printer to receive the captured projected image; and
a network communicatively coupled between the projector and the printer.
